(19) United States
(12) Patent Application Publication
(10) Pub. No.: US 2011/0147613 A1
(43) Pub. Date: Jun. 23, 2011

(54) DEVICE AND METHOD FOR ENHANCED ANALYSIS OF PARTICLE SAMPLE

(75) Inventors: Hervé Rigneault, Allauch (FR); Jérôme Wenger, Les Pennes Mirabeau (FR); Gerard Davy, Marseille (FR)

(73) Assignees: Centre National de la Recherche Scientifique- CNRS, Paris (FR); Universite Paul Cezanne Marseille III, Aix-en Provence (FR)

(21) Appl. No.: 12/937,937

(22) PCT Filed: Apr. 14, 2009
(86) PCT No.: PCT/FR09/00432

§ 371 Date: Mar. 3, 2011

(30) Foreign Application Priority Data
Apr. 14, 2008 (FR) 08/52487

(51) Int. Cl. G01N 21/64

(52) U.S. Cl. 250/458.1

(57) ABSTRACT

The present disclosure relates to a device for analyzing a dissolved particle sample, said device comprising a microscope system, said microscope system comprising support supporting said sample, an illumination source operably emitting a luminous energizing beam, an optic member focusing said luminous energizing beam into a focal point on said sample, and a spatial filter operably defining an analyzed space around the focal point, and said microscope system comprising an interface operably enhancing said luminous energizing beam, said enhancement interface including a strictly positive focal length and a refractive index greater than the refractive index of said sample, at least a portion of said enhancement interface being disposed on the path of said luminous energizing beam downstream from said support and upstream from said focal point, and at least a portion of said enhancement interface not being rigidly connected to said support. The present disclosure also relates to a method for analyzing a dissolved particle sample by such an analyzing device.

### CROSS-REFERENCE TO RELATED APPLICATIONS

This application is a National Phase Entry of International Application No. PCT/FR2009/000432, filed on Apr. 14, 2009, which claims priority to French Application 08/52487, filed on Apr. 14, 2008, both of which are incorporated by reference herein.

### TECHNICAL FIELD

This invention relates to a device and a method for enhanced analysis of a particle sample. This invention relates to the field of devices for analyzing luminescent or optically scattering particles. It relates more particularly to a device for analyzing a dissolved particle sample, said device comprising a microscope system, said microscope system comprising means of supporting said sample, illumination means capable of emitting a excitation light beam, means of focusing said excitation light beam on a focal point of said sample and spatial filtering means capable of defining an analysis volume around the focal point.

### BACKGROUND

Such a device is intended for use in any type of optical analysis application relating to particles having luminescence or scattering marking, i.e., having a specific luminescence or scattering response to an exciting light. The particles being analyzed are molecules or assemblages of molecules, e.g., molecular complexes, nanocrystals or nanobeads, and have dimensions smaller than the wavelength of the light emitted by the illumination means. It finds use, in particular, in the field of detecting dissolved fluorescent molecules, and, more particularly, in fluorescence correlation spectroscopy. It likewise finds use in biological tests and more precisely the DNA or protein chip test.

The prior art in this field comprises analysis devices including a confocal microscope system. Such a system aims to analyze a sample, e.g., dissolved, luminescent or optically scattering particles. For example, in the case of analyzing fluorescent particles, the system includes a laser source emitting a laser beam at a given wavelength, a dichroic mirror, a microscope lens having a very high degree of magnification and wide numerical aperture, optical imaging means, spatial filtering means and a detector. The laser beam is made convergent by the lens at a focal point situated in the analysis volume that one wishes to analyze. The light of the focused laser beam is then absorbed by the particles and then re-emitted at a wavelength greater than that of the laser beam, in order to next be directed to the detector. The optical imaging means are arranged so as to pair the focal point of the laser beam with the detector.

The spatial filtering means enable an analysis volume to be defined and to thereby obtain a degree of spatial resolution lower than a micrometer. To accomplish this, they include an aperture arranged upstream from the detector, in a plane conjugate with the focal plane of the microscope objective. In this way, only the photons situated in a volume around the focal point of the laser beam participate in forming the image with respect to the detector.

In order to obtain a significant amount of information about the dissolved fluorescent particles, a correlator is connected to the detector so as to analyze the temporal fluctuations of the fluorescent light emitted by the analysis volume, in order to carry out fluorescence correlation spectroscopy (FCS) detection. The fluorescence as well as the temporal fluctuations thereof are thus analyzed. These fluctuations are directly related to the scattering of the fluophores through the analysis volume. In the short term, the function of autocorrelating the luminous intensity detected enables access to the photophysical parameters of the emitters as well as to the average number of molecules detected. In the long term, this function provides information about the average residence time—the scattering time—of the molecules and about the mode of scattering thereof through the analysis volume. Such a device enables advantage to be taken of a larger aperture, so as to collect the maximum amount of light and thus fluorescence, as well as to reduce the analysis volume and consequently reduce the scattering noise in the solution.

Nevertheless, for an application wherein analysis resolution on a single molecule is desired, such a device has several disadvantages. As a matter of fact, the diffraction phenomena set a basic limit to the focal spot of the laser, and thus to the dimension of the analysis volume. These phenomena result in limitations on the counting rate per molecule at fixed power and on the maximum concentration enabling detection of single molecules, in so far as it is sought to analyze only one molecule per analysis volume. Furthermore, the reduction in background noise, due to the contribution of the Rayleigh and Raman scattering, is limited since this background noise is proportional to the dimensions of the analysis volume. These disadvantages render such devices ill-suited to the analysis of single molecules in high-concentration solutions (greater than approximately ten nanomolars).

A solution is described in the patent document FR 2 827 959 for solving the problem of defining the analysis volume. In this document, a device for measuring a sample via correlation spectroscopy includes a confocal microscope comprising an optical focusing system the field of which defines a collection volume, or analysis volume, means capable of producing an excitation beam and of directing same onto the sample through the microscope, means of detecting the intensity of the luminous flux produced by the interaction of the excitation beam on the sample and collected by the microscope, as well as means of processing the signal produced by the detection means. This device likewise comprises a photon structure increasing the luminous flux collected, which is positioned at the focal point of the optical focusing system of the microscope and forms interference fringes in the collection volume. This photon structure, for example, can be a water-resistant dielectric mirror and consist of a stack of layers of very small optical thickness. It is positioned at the focal point of the optical focusing system of the microscope in order to form interference fringes in the collection volume. On the one hand, implementation of this structure makes it possible to significantly increase the signal collected per molecule and, on the other hand, to solve the problem of defining the collection volume.

The disadvantage of this solution lies in the difficulty of obtaining sufficient rejection of the noise induced by the reflection of the excitation beam on the mirror and by the parasitic luminescence induced in the mirror. Furthermore, the maximum obtainable reduction in the analysis volume is approximately 3, which does not provide a substantial gain in practical applications.

Other solutions for improving the resolution of these analysis devices might be anticipated. In particular, in order to amplify the luminous intensity received by the detector, it can be anticipated to increase the power of the laser beam, but that is likely to photo-destroy the molecule. Another option is to increase the numerical aperture of the microscope lens, but that is made difficult in so far as the technology for microscope lenses is very advanced and is no longer finding any significant increase in the numerical aperture. Likewise, in order to limit the consequences of the diffraction phenomenon, one solution may consist in using a laser source having a shorter wavelength, but such an increase is limited with respect to the laser excitation. Another solution can implement a support means having a greater refractive index, which is made of diamond, for example, but such materials incur significant costs and are difficult to machine. Other solutions are foreseeable, such as the use of scanning near-field or stimulated luminescence depletion microscopes, however these techniques are difficult to implement and incur significant costs. Thus, no solution of the prior art enables individualized molecules to be effectively detected in high-concentration solutions while ensuring simplicity of use and a low operating and maintenance cost.

### SUMMARY

The objective of this invention is to remedy these technical problems, by enabling the analysis volume to be decreased significantly, whereby it only contains a quantity of molecules up to the limit of one, and by implementing means of enhancing both the excitation light beam and the collection of the luminescence emitted. These enhancement means are arranged so as to make the focal field defined by the excitation light beam on the sample more intense and more condensed, this field being capable of reaching dimensions smaller than the diffraction limit, thereby enabling analysis on a volume smaller than a femtoliter and thus capable of containing only a single molecule in high-concentration solutions (greater than 10 nanomolars).

The approach to the solution consists in implementing nanophotonic emission devices, also known as “photon-jet” devices, with a view to reducing the focal field defined by the excitation light beam on the sample and increasing the efficiency of collecting the emitted light. The prior art for this type of device comprises a microbead arranged on the path of a collimated beam so as to focus this beam. This gives said beam a small divergence, as well as an invariance along the axis thereof, in comparison with a normal beam, which is likely to diffract considerably over a small span. This type of device is therefore apparently incompatible with use along a highly focused light beam path, such as the excitation light beam of a microscope analysis device, which is made convergent at a focal point. Such being the case, studying the behavior of the excitation light beam partially passing through such a nanophotonic emission device, as well as the implementation of same, then enabled demonstration of a significant reduction in the analysis volume of the sample.

For this purpose, the subject matter of the invention is an analysis device of the aforementioned type, in which, besides the characteristics already mentioned, the microscope system likewise comprises means of enhancing said excitation light beam, said enhancement means having a strictly positive focal length and a refractive index greater than the refractive index of said sample, at least a portion of said enhancement means being arranged on the path of said excitation light beam, downstream from said support means and upstream from said focal point, at least a portion of said enhancement means not being integral with the support means. The enhancement means thus implemented enable the excitation light beam to be over-focused in a region of smaller dimensions than the initial analysis volume. As a matter of fact, the portion of the incident light beam which passes through the enhancement means converges in a boundary region of said enhancement means, this region being made narrower by the focal point and the refractive index of said enhancement means. The portion of the light beam which does not pass through said enhancement means will interfere with the portion which passed therethrough, according to a destructive interference phenomenon. The bulk of the luminous intensity of the incident beam is thus concentrated in a volume having a longitudinal dimension of the order of half the wavelength and having an axial dimension of the order of the wavelength, and therefore having dimensions smaller than the diffraction limit.

Furthermore, due to the refractive index value of the enhancement means, the response light beam, produced in response to the interaction of the excitation light beam on the sample and collected by the focusing means, is preferentially directed in one or more specific directions in space. As a matter of fact, the particles will re-emit light, preferably towards the enhancement means, because the refractive index of same is greater. In this way, an even greater response luminous flux will be collected and then detected, which therefore makes it possible to likewise enhance the collection of the luminescence emitted. The analysis device according to the invention, thus consisting of the combination of the enhancement means with a conventional microscope system comprising spatial filtering means, thus makes it possible to significantly reduce the analysis volume of the sample so as to analyze single molecules, while at the same time concentrating the excitation light beam in this volume so as to take advantage of signal collection per molecule which is sufficient for analysis, e.g., for correlation spectroscopy applications. In addition, the microstructured interface defined by the enhancement means can be easy to manufacture and distributed on a large scale.

In one embodiment of the invention, at least a portion of the enhancement means is integral with the support means. In this case, provisions can be made for the portion of the enhancement means integral with the support means to consist of a protrusion on said support means, said protrusion having a strictly positive curvature. Several embodiments of the enhancement means can be provided, included among which:
the portion of the enhancement means not integral with the support means includes at least one microlens,
the portion of the enhancement means not integral with the support means includes at least one microdrop, and
the portion of the enhancement means not integral with the support means includes at least one microbead.

In the case where the portion of the enhancement means not integral with the support means consists of a microbead, it is advantageously provided for the microbead(s) to have a diameter substantially between 1 and 5 micrometers. This makes it possible to optimally concentrate the luminous intensity of the excitation light beam in an analysis volume of small dimensions. In order to best optimize the dimensions of the analysis volume, provisions are made for the microbead(s) to have a diameter substantially equal to 2 micrometers.

In preferred embodiments aiming to improve the luminous intensity of the excitation light beam in an analysis volume of small dimensions, provisions are made for:
the enhancement means to be centered axially on the axis of the excitation light beam, and
the enhancement means to be centered longitudinally on the focal point of the excitation light beam.
   In an advantageous embodiment aiming to further enhance the optical emission while at the same time only slightly affecting the transmission, due to the small thickness thereof, provisions are made for the enhancement means to be at least partially covered by at least a fine metallic layer.

Preferably, the microscope system likewise comprises means of detecting the intensity of the response light beam produced in response to the interaction of the excitation light beam on the sample and collected by the focusing means. This makes it possible to carry out measurements only on the analysis volume, by measuring the luminous intensity received by the detection means in response to the excitation of the sample particles contained in the analysis volume. Preferably, the microscope system likewise comprises means of processing the signal provided by the detection means. This makes it possible to measure not only luminous response but likewise the temporal fluctuations in this luminous response, thereby providing access to a significantly larger amount of information about the particles contained in the sample.

In one particular embodiment, the support means consist of a glass substrate. Preferably, the illumination means consist of a laser source. Thus, upstream from the focusing means, there is a monochromatic and high-quality optical wavefront, collimated excitation light beam.

According to a first embodiment of the focusing means, provisions are made for them to consist of a wide numerical aperture lens (typically greater than 0.7). According to a second embodiment of said focusing means, provisions are made for them to consist of a lens having a small numerical aperture (typically less than 0.7).

The microscope system is preferably confocal, the spatial filtering means including an aperture of variable dimension. This enables the dimension of the analysis volume to be adjusted, which, in combination with the enhancement means, enables the analysis volume to be reduced significantly. The enhancement means of the excitation light beam are preferably arranged in parallel. This makes it possible to have an analysis volume covering a wide but thin surface. Detection can then be carried out with a sensor comprising a plurality of pixels.

This invention likewise relates to a method of analyzing a dissolved particle sample by means of an analysis device comprising a microscope system, said microscope system comprising means of supporting said sample, means of illumination capable of emitting an excitation light beam, means of focusing said excitation light beam at a focal point in the sample and spatial filtering means capable of defining an analysis volume around the focal point, characterized in that:
at least a portion of said excitation light beam is enhanced downstream from said support means and upstream from said focal point by means of a strictly convergent focus and a refractive index greater than the refractive index of said sample, at least a portion of which is not integral with said support means, and
the intensity of the response light beam is measured in relation to time, said response light beam being derived from the interaction of the excitation light beam with the sample in the analysis volume.

### BRIEF DESCRIPTION OF THE DRAWINGS

The invention will be better understood upon reading the detailed description of a non-limiting exemplary embodiment, accompanied by figures showing, respectively:

FIG. 1, a diagram of a fluorescence correlation spectroscopy analysis device according to a first embodiment of the invention;

FIGS. 2A to 2D, various embodiments of the enhancement means according to the invention; and

FIG. 3, a diagram of a fluorescence correlation spectroscopy analysis device according to a second embodiment of the invention.

### DETAILED DISCLOSURE OF PARTICULAR EMBODIMENTS

The focal point of the excitation light beam is understood to mean the focal point of the beam when no portion of the beam passes through at least a portion of the enhancement means. Thus, for example, it may be said a portion of the enhancement means which is arranged upstream from the focal point of the excitation light beam, so as to understand that the center of this portion of the enhancement means is arranged upstream from the focal point of the beam if there were no enhancement means.

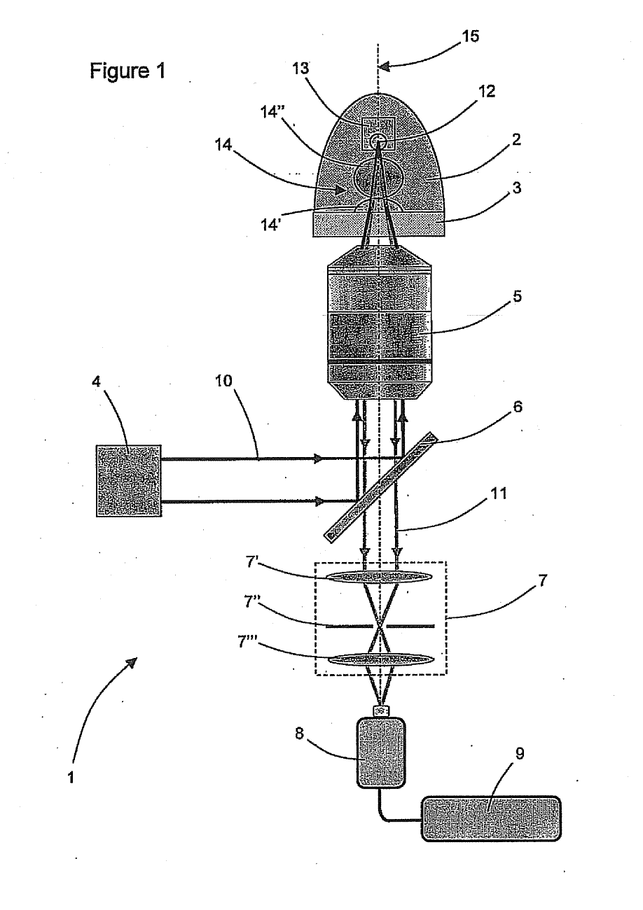

FIG. 1 shows a diagram of a fluorescence correlation spectroscopy analysis device according to a first embodiment of the invention. The analysis device aims to analyze a sample 2. This sample can be a liquid or gaseous medium, or a biological object containing particles to be analyzed. The particles to be analyzed are molecules or molecular assemblages, e.g., molecular complexes, nanocrystals or nanobeads, and have dimensions smaller than the wavelength of the light emitted by the illumination means. The analysis device includes a confocal microscope system 1. This system is an arrangement comprising means of support 3, illumination 4, focusing 5, dichroic separation 6, spatial filtering 7, detection 8, processing 9 and enhancement 14.

The support means 3 consist of a glass substrate. This substrate can be a microscope slide having a thickness of between 100 and 200 micrometers. This substrate supports the sample 2, which is advantageously enclosed in a sealed box the side walls of which are formed by self-adhesive and water-resistant blocks having a thickness of between 50 and 100 micrometers. The substrate is thus arranged at the top of said sealed box.

The illumination means 4 emit an excitation light beam 10. This beam 10 is collimated upon exiting the illumination means 4. These means advantageously consist of a laser. According to various embodiments, the laser can be a solid, diode-pumped laser operating at a wavelength of 488 nanometers or a helium-neon laser operating at a wavelength of 633 nanometers.

The excitation light beam 10 is directed towards the dichroic separation means 6. These means 6 advantageously consist of a band-stop type dichroic filter. This filter is chosen such that the cutoff wavelength thereof and the bandwidth thereof enable the excitation light beam 10 to be reflected and to transmit the response light beam 11. The wavelength of the response beam 11 is indeed greater than that of the excitation beam 10, since the particles are fluorescent. For example, in the case of Alexa 647 molecules excited at 633 nanometers, the luminous response is expected at 670 nanometers, which requires a cutoff wavelength for the dichroic filter of the order of 640 nanometers. This filter is likewise chosen so as to have maximum transmission factor for the response beam 11 wavelength.

The dichroic filter is advantageously arranged at 45° from the incident excitation beam 10. After reflecting on the dichroic separation means 6, the dichroic filter can thus direct the excitation light beam 10 towards the focusing means 5. These means 5 are capable of directing the beam towards a focal point 12 on the sample 2, through the confocal microscope system 1. For that purpose, these means 5 consist of an objective or lens.

Advantageously, and as shown in FIG. 1, the focusing means 5 consist of a microscope objective. This objective, for example, is an apochromatic lens having a magnification of 40× and a numerical aperture of 1.2. This numerical aperture enables an optimal degree of luminous intensity to be collected in response to the excitation by the light beam 10. The focusing and collection efficiency is then rendered optimal.

In another embodiment, the focusing means 5 consist of a lens. This type of focusing means has a low numerical aperture, which does not enable optimal use of the additional effect obtained by the enhancement means 14. Nevertheless, for a lower cost than a microscope objective, the low focusing and collection efficiency are compensated for by the enhancement means 14.

The excitation light beam 10 thus focused interacts with dissolved particles in the sample 2, according to a fluorescence phenomenon. In this way, each excited particle will emit a luminous response via fluorescence, at a wavelength greater than that of the excitation beam 10. A portion of this luminous response is then collected by the focusing means 5 so as to form a response light beam 11.

This response light beam 11 is sent to the detection means 8 through focusing 5, dichroic separation 6 and spatial filtering 7 means, respectively. The cutoff wavelength of the dichroic filter is, as a matter of fact, chosen so as to transmit the response light beam 11, the wavelength of which is greater than that of the excitation beam 10. In order to detect the response beam 11, the spatial filtering means further include a set of lenses 7′ and 7′″, enabling the focal plane of the focusing means 5 to be paired with the capturing plane of the detection means 8.

The spatial filtering means 7 likewise include an aperture 7″ of adjustable dimension. This aperture is arranged along the axis 15 of the response light beam 11. It is optically paired with the focal point 12 of the focusing means 5. It enables selection of a detection volume, or spatial filtering volume, around the focal point 12, since light rays not originating in this spatial filtering volume do not pass through the aperture 7″. The shorter the dimensions of the detection region are, the shorter are those of the aperture 7″ as well. The set 7 consisting of elements 7′, 7″ and 7′″ thus forms a pinhole having a variable aperture 7″, which is positioned in an intermediate image plane, whereby the microscope system pairs the focal point 12 of the excitation beam 10 with the variable aperture 7″ of the pinhole.

In other embodiments, the spatial filtering means 7 do not include any aperture 7″. As a matter of fact, they can consist of other elements enabling spatial filtering to be carried out. The microscope system thus implemented is then no longer of the confocal type. These elements, for example, can be:
a hole in a metal plate,
an optical fiber, the core diameter of which determines the effective aperture,
the detection means, the surface area of which is small, of the order of a few tens of micrometers in diameter, or
the excitation beam itself, in the case of two-photon excitation.

In the case of two-photon fluorescence excitation, the latter uses simultaneous absorption of two pump photons to excite the molecule. It is less effective than one-photon fluorescence, but, in so far as it depends quadratically on the excitation intensity, only a very small volume around the focal point is capable of effectively contributing to the signal. In this case, it is not necessary to use confocal-type filtering.

The detection means 8 enable measurement of the intensity of the response luminous flux 11 produced by the interaction of the excitation light beam 10 on sample 2 and collected by the microscope system 1. In one particular embodiment, these means 8 include electron amplification photodetectors. These photodetectors are advantageously photodiodes operating in avalanche or cascade mode (APD, for “avalanche photodiode). These photodetectors can likewise be photomultipliers. According to other particular embodiments, these detection means 8 include optical amplification photodetectors, and CCD or CMOS cameras, which are cooled, for example, with liquid air or a Peltier element.

These detection means 8 can operate according to two reader modes. According to a first mode of implementing the invention, detection is carried out continuously, wherein the optical signal emitted by the targets is detected by integrating the signal for each pixel or group of pixels of the detector, in the case where the detection means comprise several pixels. Radiometric measurements are then likewise possible between several pixels or groups of pixels. According to a second mode of implementing the invention, detection is carried out in temporal mode wherein the detector integrates the signal over short temporal ranges in relation to the process being analyzed. The information is then provided by analysis of this temporal tracing.

The signal derived from these detection means 8 is sent to the signal processing means 9. These means 9 advantageously include a counter and a correlator, which makes it possible to digitally process the data received. In particular, the counter records the value of the fluorescence luminous intensity received and the correlator carries out the temporal analysis of the fluctuations in the fluorescence luminous intensity received. This analysis can be performed in the short term and in the long term so as to obtain additional information about the dissolved particles in the sample 2. In the short term, the function of autocorrelating the luminous intensity detected enables access to the photophysical parameters of the emitters as well as the average number of molecules detected. In the long term, this function provides information about the average residence time (scattering time) of the molecules and about the mode of scattering thereof through the spatial filtering volume.

The enhancement means 14 enable the shape of the excitation light beam 10 to be modified so as to enhance the luminous flux and thereby concentrate same in an analysis volume of smaller dimensions. To accomplish this, the enhancement means 14 are arranged on the path of the excitation light beam, downstream from the support means 3 and upstream from the focal point 12. These enhancement means 14 have a strictly positive focal length and a refractive index greater than the refractive index of said sample 2. Under these conditions, the portion of the incident light beam 10 which passes through the enhancement means 14 converges in a boundary region of said enhancement means 14. This region is made narrower because their focal length is strictly positive and their refractive index is greater than that of the solution in the sample 2. The portion of the light beam 10 which does not pass through said enhancement means 14 will interfere with the portion which passed therethrough, according to a destructive interference phenomenon. The bulk of the luminous intensity of the incident beam 10 is thus concentrated in a volume having a longitudinal dimension of the order of half the wavelength and having an axial dimension of the order of the wavelength, and therefore dimensions smaller than the diffraction limit, thereby enabling a analysis volume to be reached which is smaller than a tenth of a femtoliter.

In addition, since their refractive index is greater than that of the sample 2, the response light beam 11 is directed preferentially, whereby the light is re-emitted towards the enhancement means 14. In this way, an even more significant response luminous flux 11 will be collected and then detected. The enhancement means 14 thus comprise a microstructured interface between the support means 3 and the focal point 12 of the excitation beam 10, so as to reduce the dimensions of the analysis volume being detected and to concentrate therein a luminous intensity which is greater than that without enhancement means.

The enhancement means 14 have micrometric dimensions, of the order of 1 to 5 micrometers, and a high refractive index, of the order of 1.4 to 1.6. According to various particular embodiments, the enhancement means 14 are not integral with the support means 3, are at least partially integral with said support means 3, or are entirely integral with said support means 3.

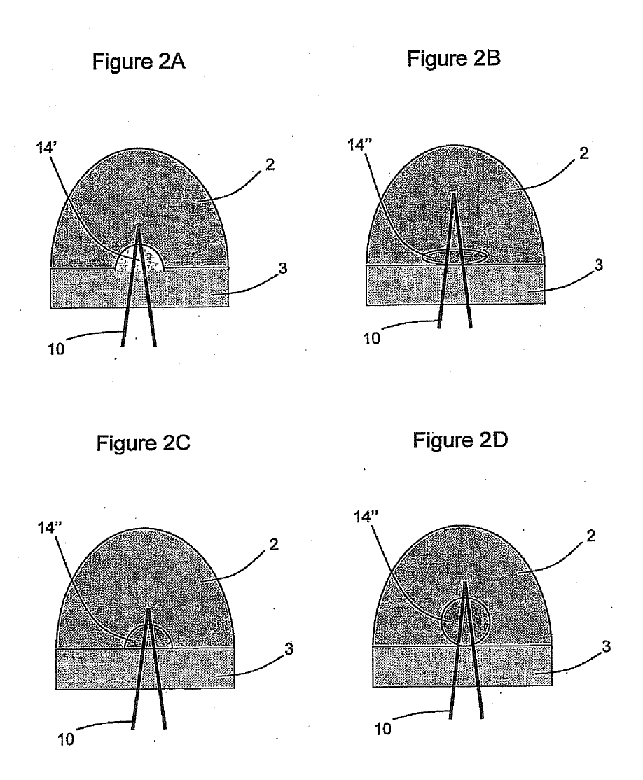

According to the embodiment shown in FIG. 2A, the enhancement means 14 are integral with the support means 3. The enhancement means thus consist of a protrusion 14′ on the support means 3. This protrusion has a strictly positive curvature whereby the focal point of the enhancement means thus comprised is strictly positive.

According to the embodiments shown in FIGS. 2B to 2D, the enhancement means 14 are not integral with the support means 3. The microstructured interface thus consisting of the enhancement means 14 can be manufactured by dispersing said means 14 on the glass substrate of said support means 3. With reference to FIG. 2B, the enhancement means 14″ consist of a convergent microlens. This lens of micrometric dimensions advantageously has a high focal length so as to best concentrate the luminous flux derived from the excitation beam 10 in a region of the lens as close as possible. This region is thus is all the more isolated from the rest of the sample 2 where other particles are likely to be excited.

With reference to FIG. 2C, the enhancement means 14″ consist of a microdrop. The focal length of this micrometric drop advantageously has a high curvature so as to best concentrate the luminous flux derived from the excitation beam 10 in a region of the drop as close as possible.

With reference to FIG. 2D, the enhancement means 14″ preferably consist of a microbead. This microbead is a dielectric bead having a high refractive index and micrometric dimensions. This bead, for example, can be made of latex or polystyrene, the index of which is equal to 1.6, and which likewise has the advantage of being more flexible than glass, so as to not undergo deterioration during the manufacture of the microstructured interface. The microbead has the advantage of having very high curvatures, thereby making it possible to optimally concentrate the luminous intensity of the excitation light beam in an analysis volume of small dimensions. The diameter of a microbead is situated between 1 and 5 micrometers, and preferably 2 micrometers.

It is understood that a person skilled in the art would be able to carry out various alternatives to these enhancement means shown in FIGS. 2A to 2D, in particular by combining the exemplary embodiments above, without thereby departing from the scope of the patent. More particularly, the enhancement means 14 can include both a portion which is integral 14′ and a portion which is not integral 14″ with the support means 3. For each of the embodiments of the above-described enhancement means 14, as well as for any possible combination thereof, said enhancement means 14 are advantageously centered axially on the axis 15 of the excitation light beam 10. They are likewise advantageously centered longitudinally on the focal point 12 of the excitation light beam 10. These centerings of the enhancement means 14 in relation to the excitation light beam 10 enable said beam 10 to be optimally enhanced.

Preferably, and for the purposes of further enhancing the optical emission, the enhancement means 14 are at least partially covered by at least one fine metallic layer. The metal used for this layer is a metal chosen from among aluminum and noble metals, such as gold, silver, copper and nickel. The thickness of this layer is advantageously less than or equal to 30 nanometers, so as to prevent having an excessively opaque layer, which would significantly reduce the transmission of the microscope system. This fine metallic layer, for example, can be a layer of gold, having a thickness equal to 20 nanometers; which entirely or partially covers the enhancement means.

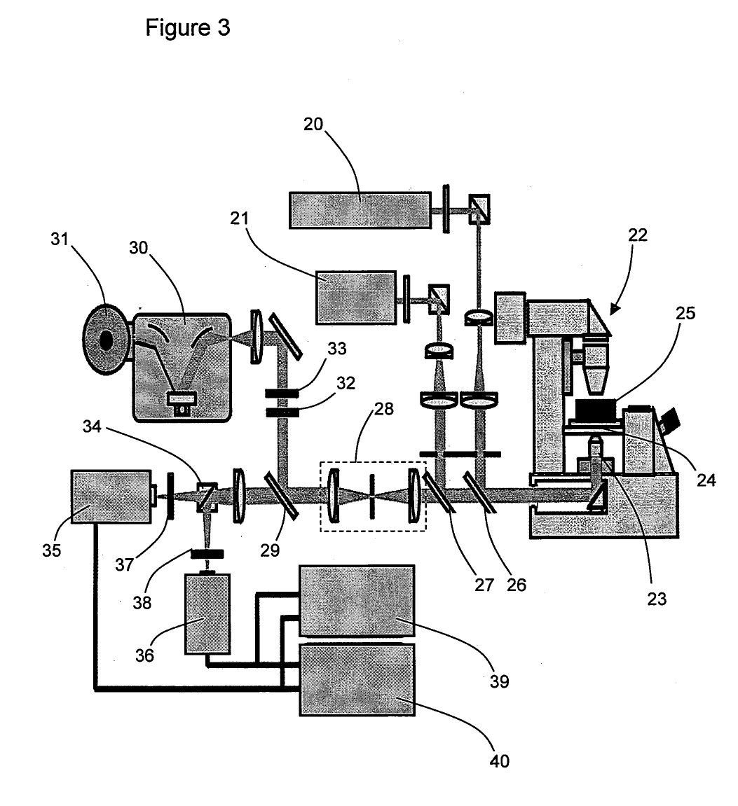

FIG. 3 shows a diagram of a fluorescence correlation spectroscopy analysis device according to a second embodiment of the invention. In this embodiment aiming to simultaneously carry out fluorescence correlation spectroscopy analysis and Raman spectroscopy analysis, the confocal microscope system includes:
a helium-neon laser source 20 emitting at 633 nanometers, for which a luminous response derived from interaction with fluorescent molecules is expected at 670 nanometers,
a diode-pumped solid laser source 21 emitting at 488 nanometers, for which a luminous response derived from interaction with fluorescent molecules is expected at 520 nanometers,
a conventional microscope device 22 comprising a microscope objective 23 and a glass slide 24 supporting a sample 25 containing the dissolved particles,
a first stop-band dichroic filter 26 around 633 nanometers,
a second stop-band dichroic filter 27 around 488 nanometers,
a pinhole 28 comprising an adjustable aperture and two lenses arranged so as to spatially filter a detection volume around the focal point of the beams derived from the two laser sources 20 and 21,
a third high-pass dichroic filter 29 the cutoff wavelength of which is situated between 520 and 670 nanometers, so as to separate the luminous responses in fluorescence derived from the interaction of the particles with each of the laser sources 20 and 21,
a Raman spectroscopy device 30 for analyzing the fluorescence of the excited particles at 488 nanometers,
a separator cube 34,
two avalanche photodiodes 35 and 36 preceded by filters 37 and 38, respectively, for measuring the intensity of the fluorescence luminous flux at 670 nanometers, collected by the microscope system, and
a counter 39 and a correlator 40 enabling the temporal fluctuations in the fluorescence luminous intensity to be measured at 633 nanometers.

The spectroscopy device 30 enables the spectral composition of the light to be analyzed over a spectral range of 500 to 700 nanometers for an excitation wavelength of 488 nanometers. The intensity of the light emitted is measured by a detector 31, which can be single-channel, e.g., of the photomultiplier type, or multi-channel, e.g., of the CCD type. A high-pass filter 32 and a stop-band filter are advantageously attached to the device 30 so as to improve the signal quality transmitted to the detector 31. By combining fluorescence correlation spectroscopy analysis and Raman spectroscopy analysis, such an analysis device according to the invention thereby makes it possible to obtain not only statistical and temporal information about the dissolved particles, but likewise information about particles taken individually.

The above-described combination of the enhancement means and a conventional confocal microscope system, according to any of the above-described embodiments, enables the analysis volume to be decreased and detection to be enhanced. A highly effective detection system where individual particles are detected may also be envisaged. This system makes it possible to obtain information to be obtained at the individual molecule scale, which is not accessible by overall measurements (temporal dynamics and statistical distribution of the reactions). This offers new study and diagnostic means, in particular for transient or on-going molecular association analysis applications.

The above-described embodiments of this invention are provided for illustrative purposes and are in no way limitative. It is understood that a person skilled in the art would be able to carry out various alternatives of the invention, in particular with the development of technologies, without thereby departing from the scope of the patent.

Thus, the means of enhancing 14 the excitation light beam 10 can be arranged in parallel. An exemplary embodiment is a microbead mat arranged against the glass substrate 3. This microstructured assembly of microbeads enables obtainment of an analysis volume having a large surface area and a small thickness. Detection can then likewise be carried out with a CCD or CMOS multi-pixel sensor. In the same way, the particles being analyzed can likewise have chemiluminescence, bioluminescence, scattering (Rayleigh or Hyper-Rayleigh), vibrational spectroscopy (spontaneous or stimulated Raman), thermal emissivity or reflection properties (in the case of granulometric studies).

1-20. (canceled)

21. A device for analyzing a dissolved particle sample, said device comprising a microscope system, said microscope system comprising a support supporting said sample, an illumination source operably emitting a excitation light beam, an optic member focusing said excitation light beam on a focal point of said sample and spatial filter operably defining an analysis volume around said focal point, said microscope system comprising an interface operably enhancing said excitation light beam, said enhancement interface including a strictly positive focal length and a refractive index greater than the refractive index of said sample, at least a portion of said enhancement interface being arranged on the path of said excitation light beam, downstream from said support and upstream from said focal point, and at least a portion of said enhancement interface not being integral with said support.

22. The analysis device of claim 21, wherein at least a portion of said enhancement interface is integral with said support.

23. The analysis device of claim 22, wherein said portion of said enhancement interface integral with said support includes a protrusion on said support, said protrusion having a strictly positive curvature.

24. The analysis device of claim 21, wherein said portion of said enhancement interface not integral with said support includes at least one microlens.

25. The analysis device of claim 22, wherein said portion of said enhancement interface not integral with said support includes at least one microlens.

26. The analysis device of claim 23, wherein said portion of said enhancement interface not integral with said support includes at least one microlens.

27. The analysis device of claim 21, wherein said portion of said enhancement interface not integral with said support includes at least one microdrop.

28. The analysis device of claim 21, wherein said portion of said enhancement interface not integral with said support includes at least one microbead.

29. The analysis device of claim 28, wherein said microbead(s) have a diameter substantially between 1 and 5 micrometers.

30. The analysis device of claim 29, wherein said microbead(s) have a diameter substantially equal to 2 micrometers.

31. The analysis device of claim 21, wherein said enhancement interface is centered axially on an axis of said excitation light beam.

32. The analysis device of claim 21, wherein said enhancement interface is centered longitudinally on said focal point of said excitation light beam.

33. The analysis device of claim 21, wherein said enhancement interface is at least partially covered with at least a fine metallic layer.

34. The analysis device of claim 21, wherein said microscope system comprises a detector operably detecting intensity of a response light beam produced in response to an interaction of said excitation light beam on said sample and collected by said focusing optic member.

35. The analysis device of claim 34, wherein said microscope system comprises a digital processor operably processing a signal provided by said detector.

36. The analysis device of claim 21, wherein said support includes a glass substrate.

37. The analysis device of claim 21, wherein said illumination source includes a laser source.

38. The analysis device of claim 21, wherein said focusing optic member includes an objective.

39. The analysis device of claim 21, wherein said focusing optic member includes a lens.

40. The analysis device of claim 21, wherein said microscope system is confocal, and the spatial filter includes an aperture of variable dimension.

41. The analysis device of claim 21, wherein said enhancing excitation light beam is arranged in parallel.

42. The method of dissolving a particle sample, said method comprising a microscope system, said microscope system comprising a support supporting said sample, an illumination source operably emitting an excitation light beam, an optic member focusing said excitation light beam at a focal point of said sample and spatial filter operably defining an analysis volume around said focal point including:
at least a portion of said excitation light beam is enhanced downstream and upstream from said focal point by a strictly convergent focus and a refractive index greater than the refractive index of said sample, at least a portion of the illumination source not being integral with said support; and
the intensity of the responsive light beam being measured in relation to time, said responsive light beam being derived from the interaction of the excitation light beam with said sample in the analysis volume.
